(19) United States
(12) Patent Application Publication
(10) Pub. No.: US 2024/0199941 A1
(43) Pub. Date: Jun. 20, 2024

(54) METHOD FOR SELECTING SCALE DISPERSANT

(71) Applicant: FUJI ELECTRIC CO., LTD., Kawasaki-shi (JP)

(72) Inventors: Azusa WADA, Tokyo (JP); Shinya UI, Tokyo (JP); Hideki YAMAMOTO, Osaka (JP)

(73) Assignee: FUJI ELECTRIC CO., LTD., Kawasaki-shi (JP)

(21) Appl. No.: 18/592,705

(22) Filed: Mar. 1, 2024

Related U.S. Application Data
(63) Continuation of application No. PCT/JP2023/007552, filed on Mar. 1, 2023.

(30) Foreign Application Priority Data
Mar. 11, 2022 (JP) 2022-038286

(51) Int. Cl. C09K 8/528

(52) U.S. Cl. CPC C09K 8/528

(57) ABSTRACT

A method for selecting a scale dispersant compatible with characteristics of a target water and scale is deposited. A method for selecting a scale dispersant, comprising steps of obtaining a coordinate Cₛ of an intrinsic physical property value, based on Hansen solubility, of a target scale; a step of obtaining a coordinate C_{w} of an intrinsic physical property value, based on Hansen solubility, of a target water; and selecting a scale dispersant based on a positional relationship between the coordinate Cₛ of the intrinsic physical property value of the target scale and the coordinate C_{w} of the intrinsic physical property value of the target water.

### TECHNICAL FIELD

The present invention relates to a method for selecting a scale dispersant.

### BACKGROUND ART

Conventionally, scale adhesion has been a problem in systems equipped with a flowing fluid system, such as a power generation plant system, a ship system, a boiler system, or a steel plant system.

It is known that a predetermined agent is used to dissolve and remove scale that has already been formed. Conventionally, in a plant system, such an agent, an oxidizing agent such as hydrofluoric acid, acetic acid, sulfuric acid, or hydrochloric acid, or an alkaline agent such as sodium hydroxide, sodium carbonate, or sodium hydrogen carbonate has been used based on empirical data.

For example, in a geothermal power plant, a method for suppressing precipitation of silica by injecting an alkali agent into a fluid having a high calcium concentration and a high dissolved silica concentration without precipitating calcium silicate hydrate (CSH) is known (see, for example, Patent Document 1). In addition, as the agent, a scale adhesion inhibitor that consists of an amidated product of (poly)alkylene polyamine or a derivative thereof (A) and a quaternary ammonium salt of an anionic group-containing polymer having a degree of neutralization of 30 to 100 mol % (B) and has a water content of 10 to 80% by mass is known (see, for example, Patent Document 2).

### REFERENCE DOCUMENT LIST

### Patent Documents

Patent Document 1: JP 2011-196197 A

Patent Document 2: JP 2005-46679 A

### SUMMARY OF THE INVENTION

### Problem to be Solved by the Invention

Among various plant systems in which scale adhesion is a problem, in a geothermal power plant, the dissolved silica concentration is high, and thus, scale, such as one of amorphous silica, is particularly likely to precipitate, posing problems. For example, the silica concentration of cooling water in a typical plant is at most 150 ppm, whereas the silica concentration of flowing geothermal water in a geothermal power plant in Japan is about 450 to 900 ppm.

In addition, the silica-based scale component in a geothermal power plant varies depending on the dissolved metal component contained in geothermal water. Because of this, different types of silica-based scale are deposited in different geothermal power plants. Therefore, it has been difficult to select the most suitable agent for controlling scale in each plant. Conventionally, a known agent has been used based on empirical data, but the most suitable agent selection has not been possible to carry out, and an unexpected precipitate or the like has sometimes occurred.

When a silica-based scale precipitates, a periodic overhaul inspection of a turbine unit, a steam separator, a heat exchanger, or the like of a geothermal power plant is essential. When scale is removed, it is necessary to use a cleaning agent such as hydrofluoric acid, and the removed scale is an industrial waste, which increases costs. Because of these, there is a need for a technique for selecting the most suitable agent for scale prevention for each geothermal power plant.

### Means for Solving the Problem

The present inventors have studied the use of a Hansen solubility parameter (HSP) technique in order to select an agent according to the characteristics of a fluid such as geothermal water, including a scale-causing material. In particular, the present inventors have conceived of selecting an agent that can accommodate even differences in dissolved silica concentration, dissolved metal species, and concentration for each geothermal power generation plant, based on the HSP coordinates of a scale component and a fluid including a scale-causing material, and have completed the present invention.

According to one embodiment, the present invention relates to a method for selecting a scale dispersant, including: a step of obtaining a coordinate Cₛ of an intrinsic physical property value, based on Hansen solubility, of a target scale; a step of obtaining a coordinate C_{w} of an intrinsic physical property value, based on Hansen solubility, of a target water; and a step of selecting a scale dispersant based on a positional relationship between the coordinate Cₛ of the intrinsic physical property value of the target scale and the coordinate C_{w} of the intrinsic physical property value of the target water.

In the method for selecting a scale dispersant, when the intrinsic physical property values are expressed by three-dimensional coordinates consisting of a dispersion force δD, a dipole-dipole force δP, and a hydrogen bonding force δH, and when coordinates of the target scale are designated as Cₛ(δDₛ, δPₛ, δHₛ), coordinates of the target water are designated as C_{w}(δD_{w}, δP_{w}, δH_{w}), coordinates of a scale dispersant to be selected are designated as Cₐ(δDₐ, δPₐ, δHₐ), and a distance between the coordinates Cₛ of the intrinsic physical property values of the target scale and the coordinates C_{w} of the intrinsic physical property values of the target water is designated as Rₐ, the step of selecting a scale dispersant is preferably a step of selecting a substance having coordinates Cₐ satisfying the following expression (1):

4(δDₐ−δD_{w})²+(δPₐ−δP_{w})²+(δHₐ−δH_{w})²≤(Rₐ)² (1)

as the scale dispersant.

In the method for selecting a scale dispersant, when the intrinsic physical property values are expressed by two-dimensional coordinates consisting of a dispersion force δD and a dipole-dipole force δP, and when coordinates of the target scale are designated as Cₛ(δDₛ, δPₛ), coordinates of the target water are designated as C_{w}(δD_{w}, δP_{w}), and coordinates of a scale dispersant to be selected are designated as Cₐ(δDₐ, δPₐ), the step of selecting a scale dispersant is preferably, (i) when δPₛ≥δP_{w}, a step of selecting a substance having coordinates Cₐ satisfying δPₐ≤δP_{w} as the scale dispersant, and (ii) when δPₛ≤δP_{w}, a step of selecting a substance having coordinates Cₐ satisfying δPₐ≥δP_{w} as the scale dispersant.

In the method for selecting a scale dispersant, the step of selecting a scale dispersant is preferably, (ia) when δPₛ≥δP_{w} and δDₛ≥δD_{w}, a step of selecting a substance having coordinates Cₐ satisfying δPₐ≤δP_{w} and δDₐ≤δD_{w} as the scale dispersant, (ib) when δPₛ≥δP_{w} and δDₛ≤δD_{w}, a step of selecting a substance having coordinates Cₐ satisfying δPₐ≤δP_{w} and δDₐ≥δD_{w} as the scale dispersant, (iia) when δPₛ≤δP_{w} and δDₛ≤δD_{w}, a step of selecting a substance having coordinates Cₐ satisfying δPₐ≥δP_{w} and δDₐ≥δD_{w} as the scale dispersant, and (iib) when δPₛ≤δP_{w} and δDₛ≥δD_{w}, a step of selecting a substance having coordinates Cₐ satisfying δPₐ≥δP_{w} and δDₐ≤δD_{w} as the scale dispersant.

In the method for selecting a scale dispersant, when the intrinsic physical property values are expressed by two-dimensional coordinates consisting of a dispersion force δD and a dipole-dipole force δP, and when coordinates of the target scale are designated as Cₛ(δDₛ, δPₛ), coordinates of the target water are designated as C_{w}(δD_{w}, δP_{w}), coordinates of a scale dispersant or a modifying group therefor to be selected are designated as Cₐ(δDₐ, δPₐ), and a distance between the coordinates C_{w} and the coordinates Cₛ is designated as Rₐ, the step of selecting a scale dispersant is preferably, (1) when Rₐ is 9.5 or less, a step of selecting a substance having coordinates Cₐ satisfying δDₐ being (δD_{w}−0.5) to (δD_{w}+4.5) and δPₐ being (δP_{w}−10) to (δP_{w}+8) as the scale dispersant, and (2) when Rₐ is greater than 9.5, a step of selecting a substance having coordinates Cₐ satisfying δDₐ being (δD_{w}+0.5) to (δD_{w}+4.5) and δPₐ being (δP_{w}−10) to (δP_{w}+8) as the scale dispersant.

In the method for selecting a scale dispersant, the target water is preferably selected from clean water, sewage, well water, seawater, freshwater, river water, pure water, geothermal water, industrial water, and factory effluent.

In the method for selecting a scale dispersant, the scale dispersant is preferably selected from allylamine, diallylamine, maleic acid, ascorbic acid, nicotinic acid, acrylic acid, dimethyldiallylammonium chloride, difurfuryl disulfide, sulfur dioxide, or a polymer including one monomer thereof, or two or more monomers thereof.

In the method for selecting a scale dispersant, the scale dispersant preferably includes a chelating agent.

According to another embodiment, the present invention relates to a method for producing a scale dispersant, including: a step of selecting a scale dispersant or a modifying group having a predetermined coordinate based on any of the methods for selecting a scale dispersant described above; and a step of preparing a scale dispersant based on the selected scale dispersant or modifying group.

According to yet another embodiment, the present invention relates to a method for suppressing scale adhesion in a geothermal power generation system, the method including:

(I) a step of selecting a scale dispersant by any of the methods for selecting a scale dispersant described above; and
(II) a step of adding the selected scale dispersant to geothermal water in the geothermal power generation system, in which the step of selecting a scale dispersant includes a step of obtaining a coordinate C_{w} of an intrinsic physical property value of the geothermal water.

The method for suppressing scale adhesion preferably includes a step of obtaining coordinates C_{w} of intrinsic physical property values of geothermal water derived from two or more different production wells, and includes a step of selecting a scale dispersant corresponding to the geothermal water derived from each of the production wells.

### Effects of the Invention

According to the method for selecting a scale dispersant according to the present invention, it is possible to select a suitable scale dispersant that corresponds to components of the target water and the target scale. Then, by using the dispersant selected by the method for selecting a scale dispersant according to the present invention, precipitation of scale and growth can be suppressed, the maintenance cycle of the plant can be reduced, and an industrial waste caused by the scale can be reduced.

### BRIEF DESCRIPTION OF THE DRAWINGS

FIG. 1 is a diagram illustrating an example of the method for selecting a dispersant according to a first aspect of a first embodiment of the present invention, and showing a method for selecting intrinsic physical property values based on Hansen solubility on three-dimensional coordinates.

FIG. 2 is a diagram illustrating an example of the method for selecting a dispersant according to a second aspect of the first embodiment of the present invention, and showing a method for selecting intrinsic physical property values based on Hansen solubility independently of a δH axis.

FIG. 3 is a diagram obtained by projecting the three-dimensional coordinate system shown in FIG. 2 onto a two-dimensional coordinate system composed of a δD axis and a δP axis, and illustrating a first quadrant Q1, a second quadrant Q2, a third quadrant Q3, and a fourth quadrant Q4 when a δD_{w} axis and a δP_{w} axis set based on the coordinates of the target water are set.

FIG. 4 is a diagram illustrating an example of the method for selecting a scale dispersant according to a third aspect of the first embodiment of the present invention, and showing preferable ranges of intrinsic physical property values δDₐ and δPₐ, based on Hansen solubility, of a substance suitable as a dispersant for a scale having good affinity with the target water.

FIG. 5 is a diagram illustrating an example of the method for selecting a scale dispersant according to the third aspect of the first embodiment of the present invention, and showing preferable ranges of intrinsic physical property values δDₐ and δPₐ, based on Hansen solubility, of a substance suitable as a dispersant for a scale having poor affinity with the target water.

FIG. 6 is a diagram conceptually illustrating an example of a geothermal power generation system to which the method for suppressing scale adhesion according to a third embodiment of the present invention is applied.

### MODE FOR CARRYING OUT THE INVENTION

Hereinafter, embodiments of the present invention will be described with reference to drawings. However, the present invention is not limited by the embodiments described below.

### First Embodiment: Method for Selecting Scale Dispersant

According to a first embodiment, the present invention relates to a method for selecting a scale dispersant. The method for selecting a scale dispersant includes the following steps:
(a) obtaining a coordinate Cₛ of an intrinsic physical property value, based on Hansen solubility, of a target scale;
(b) obtaining a coordinate C_{w} of an intrinsic physical property value, based on Hansen solubility, of a target water; and
(c) selecting a scale dispersant based on a positional relationship between the coordinate Cₛ of the intrinsic physical property value of the target scale and the coordinate C_{w} of the intrinsic physical property value of the target water.

In the present invention, the scale dispersant is a substance that, when added to a target water, can suppress precipitation of scale precursor and/or suppress adhesion of new scale precursor to scale that has already been deposited, to reduce the amount of a scale deposited as compared with when the scale dispersant is not used. The scale dispersant may be a low molecular weight compound or a high molecular weight compound. In addition, the scale dispersant may be composed of a single substance or be a mixture of two or more substances. Herein, the term scale dispersant is sometimes simplified and is simply referred to as a dispersant.

In the present invention, the target scale refers to scale on which a scale dispersant is caused to act and the adhesion of which is to be suppressed. The target scale may be any scale and may can include an inorganic compound and an organic compound. More specifically, the target scale may be scale that is deposited by a substance and adheres, the substance being dissolved in a flowing fluid in a power generation plant system such as one that is a geothermal, thermal, nuclear, hydropower, or biomass power generation plant, a ship system such as an exhaust gas cleaning system (EGCS) or a seawater desalination system, a boiler system such as a factory heating heat source or a building heating and hot water supply system, a steel plant system such as a cooling water system or a cleaning water system, or the like, and the type thereof is not particularly limited. For example, in a geothermal power plant, the target scale may be a multi-component scale deposited in layers on the base material of a pipe, a heat exchanger, a turbine, a drain, or the like that constitutes the plant, and examples thereof include a silica-based scale.

In the present invention, the target water is a fluid including a scale precursor, and may be any water-based fluid in which scale generation is a concern. Examples of the target water include, but are not limited to, clean water, sewage, well water, seawater, freshwater, river water, pure water, geothermal water, industrial water, and factory effluent.

Examples of the intrinsic physical property value based on Hansen solubility can include a dispersion force δD, a dipole-dipole force δP, and a hydrogen bonding force δH. In a first aspect of the present embodiment, the method for selecting a scale dispersant can be based on a three-dimensional coordinate space consisting of three intrinsic physical property values. The three-dimensional coordinates are preferably orthogonal three-dimensional coordinates. In second and third aspects of the present embodiment, the method for selecting a scale dispersant can be based on a two-dimensional coordinate space consisting of two intrinsic physical property values: a dispersion force δD and a dipole-dipole force δP.

In step (a), a coordinate of an intrinsic physical property value, based on Hansen solubility, of a target scale is obtained. The coordinates Cₛ(δDₛ, δPₛ, δHₛ) of the intrinsic physical property values of the target scale can generally be obtained experimentally. For example, a step of collecting the target scale at a desired place in a target plant to analyze the layer configuration and the components of the scale, and a step of experimentally obtaining the coordinates of the intrinsic physical property values from the components are included.

The coordinates Cₛ of the intrinsic physical property values of the target scale can also be estimated from the composition ratio of the components in the target water. This is useful when no scale can be collected, for example, because it is difficult to stop the operation of a plant system through which the target water flows or the scale cannot be peeled off because of strong adhesion, or when it is necessary to obtain the composition of the scale in a simplified manner. The composition of the target water flowing through the plant system also varies depending on the location of the plant system, and thus, the target water can be collected at a desired place. For example, in a geothermal power plant, geothermal water flowing through a production well, an injection well, a heat exchanger, or the like can be collected to determine the coordinates of the intrinsic physical property values of the target scale.

The collected target water can be analyzed by using any analytical method. The analytical method can be carried out based on a trace element analysis method. For example, elemental analysis can be carried out by a method using inductively coupled plasma, and more specifically, an ICP-MS analysis method can be used, and the above method is not limited to a specific method.

The step of experimentally obtaining the coordinates of the intrinsic physical property values from the components of the actually collected scale or from the elemental analysis results of the target water can be carried out, for example, by a permeation rate method involving allowing a solvent to permeate into scale particles to evaluate affinity.

In step (b), a coordinate of an intrinsic physical property value, based on Hansen solubility, of a target water is obtained as in step (a). The coordinates C_{w}(δD_{w}, δP_{w}, δH_{w}) of the intrinsic physical property values of the target water can also be obtained experimentally. Alternatively, the coordinates of the intrinsic physical property values of the target water can also be obtained from values in the literature or from a database. In addition, the coordinates of the intrinsic physical property values of the target water can also be obtained by using Hansen solubility parameter software HSPiP (Hansen Solubility Parameter in Practice).

In step (c), a suitable scale dispersant is selected based on a positional relationship in a coordinate space between the coordinate Cₛ of the intrinsic physical property value of the target scale and the coordinate C_{w} of the intrinsic physical property value of the target water. A more specific method and criteria for selection in step (c) can include a plurality of aspects. Hereinafter, each aspect of step (c) of selecting a scale dispersant will be described.

### First Aspect: Selection in Three-Dimensional Coordinates

According to a first aspect, step (c) of selecting a scale dispersant relates to a selection method in a three-dimensional coordinate space. When the coordinates of the target scale are designated as Cₛ(δDₛ, δPₛ, δHₛ), the coordinates of the target water are designated as C_{w}(δD_{w}, δP_{w}, δH_{w}), the coordinates of a scale dispersant to be selected are designated as Cₐ(δDₐ, δPₐ, δHₐ), and the distance between the coordinates Cₛ of the intrinsic physical property values of the target scale and the coordinates C_{w} of the intrinsic physical property values of the target water is designated as Rₐ, step (c) of selecting a scale dispersant according to the first aspect is a step of selecting a substance having coordinates Cₐ satisfying the following expression (1):

4(δDₐ−δD_{w})²+(δPₐ−δP_{w})²+(δHₐ−δH_{w})²≤(Rₐ)² (1)

as the scale dispersant.

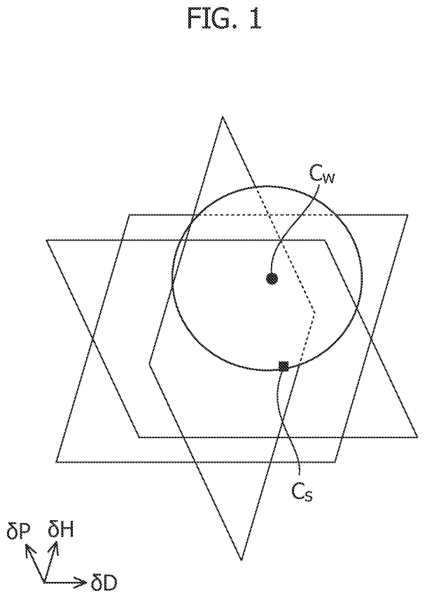

With reference to FIG. 1, in a three-dimensional coordinate space consisting of a dispersion force δD, a dipole-dipole force δP, and a hydrogen bonding force δH, a sphere centered at the coordinates C_{w} of the target water and having a radius Rₐ is shown. Here, Rₐ is the distance between the coordinates C_{w} of the target water and the coordinates Cₛ of the target scale. Rₐ is defined by the following expression (2):

Rₐ=[4(δDₛ−δD_{w})²+(δPₛ−δP_{w})²+(δHₛ−δH_{w})²]^{1/2} (2)

In the present aspect, a substance having coordinates Cₐ on the surface of a sphere centered at the coordinates C_{w} of the target water and having a radius Rₐ and inside the sphere can be selected as the scale dispersant. A substance having such a coordinate positional relationship with respect to the coordinates C_{w} of the target water and the coordinates Cₛ of the target scale can be preferably used as a dispersant because the target scale and the target scale dispersant have good affinity with the target water. I In addition, among others, a substance in which the coordinates Cₐ are located close to the coordinates C_{w} of the target water is more preferable as the dispersant.

In the present invention, the substance having coordinates Cₐ may be a compound that functions alone as a dispersant. The compound may be a low molecular weight compound such as an acid or a chelating agent, or a high molecular weight compound composed of one or more repeating units, and is not particularly limited. In addition, the substance having coordinates Cₐ may be a monomer constituting a repeating unit of a polymer compound, or a modifying group alone of a compound that functions as a dispersant. Once the range of the coordinates Cₐ(δDₐ, δPₐ, δHₐ) is determined by expression (1) above, a substance satisfying such coordinates can be selected based on information in a database. According to the present invention, not only a compound that functions alone as a dispersant, but also a moiety of the compound such as a monomer or a modifying group can be regarded as a dispersant and can be added as a selection option. Because of this, it is possible to select an effective dispersant from a wider range of options, which is advantageous.

Examples of the main chain of a polymer compound that can be selected as a substance having coordinates Cₐ include an allylamine polymer and a diallylamine polymer, and a monomer constituting these can also be selected as a substance having coordinates Cₐ. In addition, examples of the modifying group for a polymer compound include maleic acid, ascorbic acid, nicotinic acid, acrylic acid, dimethyldiallylammonium chloride, difurfuryl disulfide, and sulfur dioxide, which can polymerize with a monomer constituting the main chain. The chelating agent may be one that forms a complex or coordinates with a substance commonly included in the target scale, such as calcium, iron, or aluminum, and examples of the chelating agent include ethylenediaminetetraacetic acid (EDTA), diethylenetriaminepentaacetic acid (DTPA), and hydroxyethylethylenediaminetriacetic acid (HEDTA). However, in the present invention, the compound, monomer, or modifying group serving as an option is not limited to the above, and they may be any substance having coordinates Cₐ(δDₐ, δPₐ, δHₐ) satisfying a predetermined condition.

The step of selecting a scale dispersant according to the first aspect carries out dispersant selection using HSP based on the novel idea of selecting a substance having coordinates within a sphere centered at water and having a radius Ra with respect to the target scale, and is highly advantageous in that it is possible to select a dispersant that is highly effective as compared with a conventional technique.

### Second Aspect: Selection with Coordinates of Target Water as Reference Axis in Two-Dimensional Coordinate Space

According to a second aspect, step (c) of selecting a scale dispersant relates to a selection method in a two-dimensional coordinate space consisting of a dispersion force δD and a dipole-dipole force δP. When the coordinates of the target scale are designated as Cₛ(δDₛ, δPₛ), the coordinates of the target water are designated as C_{w}(δD_{w}, δP_{w}), and the coordinates of a scale dispersant to be selected are designated as Cₐ(δDₐ, δPₐ), the step of selecting a scale dispersant according to the second aspect is,

(i) when δPₛ≥δP_{w}, a step of selecting a substance having coordinates Cₐ satisfying δPₐ≤δP_{w} as the scale dispersant, and
(ii) when δPₛ≤δP_{w}, a step of selecting a substance having coordinates Cₐ satisfying δPₐ≥δP_{w} as the scale dispersant.

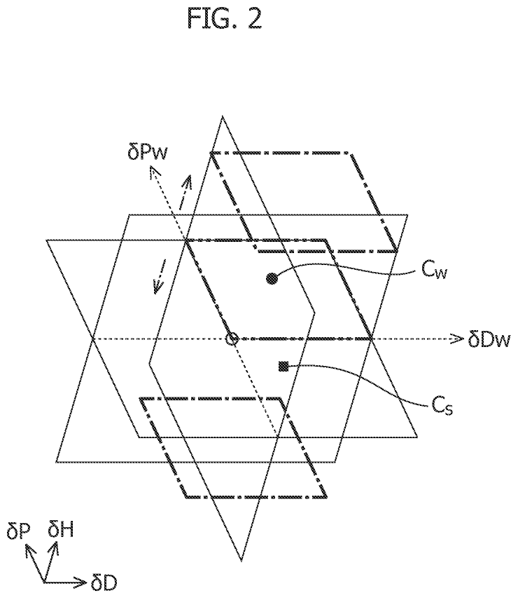

With reference to FIG. 2, in a three-dimensional coordinate space consisting of a dispersion force δD, a dipole-dipole force δP, and a hydrogen bonding force δH, the coordinates C_{w} of the target water and the coordinates Cₛ of the target scale are plotted. In FIG. 2, the δH axis direction is represented by a dashed-dotted arrow. In the present aspect, a selection step that does not depend on the δH axis is carried out. The reason why it is not necessary to consider the hydrogen bonding force δH when selecting a dispersant is that it is thought, based on an experiment, that the influence of the δH term is small when considering the affinity with the target water.

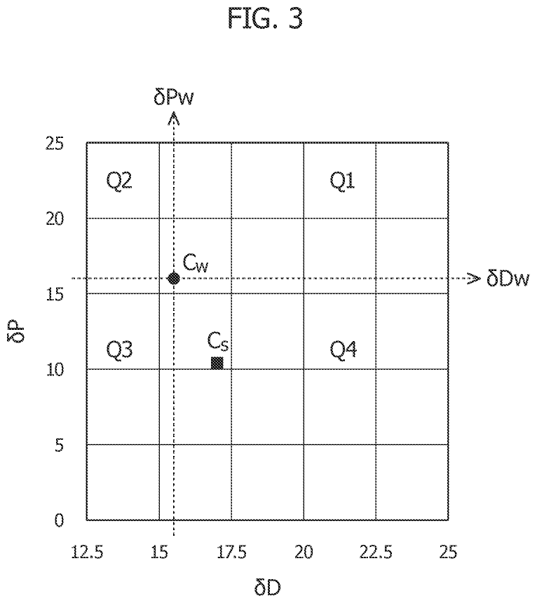

A selection method that does not depend on the δH axis can be studied in a two-dimensional coordinate space consisting of the dispersion force δD and the dipole-dipole force δP. Such a two-dimensional coordinate space is shown in FIG. 3. In FIGS. 2 and 3, a δD_{w} axis parallel to the δD axis and a δP_{w} axis parallel to the δP axis that pass through the coordinates C_{w}(δD_{w}, δP_{w}) of the target water are set. The δD_{w} axis and the δP_{w} axis are each shown by a broken line.

A specific selection method in the present aspect is to select, as a dispersant, a substance having coordinates Cₐ in a coordinate region symmetrical about the δD_{w} axis with respect to a coordinate region in which the coordinates Cₛ of the target scale are present. This is because when considering the affinity with the target water, the D term, which is the London dispersion force of the target scale coordinates Cₛ, can be brought closer to the coordinates Cw of the target water. In the present aspect and also a third aspect described later, the definition of the substance having coordinates Cₐ may be the same as in the first aspect. A compound, a monomer, a modifying group, or the like having coordinates Cₐ(δDₐ, δPₐ) within a predetermined range can be selected as the dispersant.

In FIG. 3, the two-dimensional coordinate space is divided into a first quadrant Q1, a second quadrant Q2, a third quadrant Q3, and a fourth quadrant Q4 by the δDw axis and the δPw axis. For example, when the coordinates Cₛ of the target scale is in the fourth quadrant Q4 as shown in the figure, the coordinate regions symmetrical about the δDw axis with respect to the coordinate region in which the coordinates Cₛ of the target scale are present are the first quadrant Q1 and the second quadrant Q2. Therefore, when the coordinates Cₛ of the target scale is in the fourth quadrant Q4, a substance having coordinates Cₐ(δDₐ, δPₐ) in the first quadrant Q1 or the second quadrant Q2 is selected as the dispersant. When the coordinates Cₛ of the target scale is in the third quadrant Q3 although not shown, similarly, the coordinate regions symmetrical about the δD_{w} axis with respect to the coordinate region in which the coordinates Cₛ of the target scale are present is the first Quadrant Q1 and second quadrant Q2, and a substance having coordinates Cₐ(δDₐ, δPₐ) in the first quadrant Q1 or the second quadrant Q2 is selected as the dispersant. In other words, when the coordinates C_{w} of the target water and the coordinates Cₛ of the target scale satisfy δPₛ≤δP_{w}, a substance having coordinates Cₐ satisfying δPₐ≥δP_{w} is selected as the scale dispersant. The value of δDₐ is not particularly limited.

On the other hand, when the coordinates Cₛ of the target scale is in the first quadrant Q1 or the second quadrant Q2, the coordinate regions symmetrical about the δD_{w} axis with respect to the coordinate region in which the coordinates Cₛ of the target scale are present are the first quadrant Q3 and the second quadrant Q4. Therefore, a substance having coordinates Cₐ(δDₐ, δPₐ) in the third quadrant Q3 or the fourth quadrant Q4 is selected as the dispersant. In other words, when the coordinates C_{w} of the target water and the coordinates Cₛ of the target scale satisfy δPₛ≥δP_{w}, a substance having coordinates Cₐ satisfying δPₐ≤δP_{w} is selected as the scale dispersant. The value of δDₐ is not particularly limited.

In either case, the value of the dispersant hydrogen bonding force δH term is not limited, and δHₐ may have any value.

Next, as a variation of the second aspect, a method for selecting, as the dispersant, a substance having coordinates Cₐ(δDₐ, δPₐ) in a region on the diagonal to a coordinate region in which the coordinates Cₛ of the target scale are present with respect to the coordinates C_{w} of the target water will be described. Here, a certain region and a region on the diagonal refer to two regions including vertical angles formed by the intersection of the δD_{w} axis and the δP_{w} axis.

According to the variation of the second aspect, when the coordinates Cₛ of the target scale is in the fourth quadrant Q4 as shown in the figure, a substance having coordinates Cₐ(δDₐ, δPₐ) in the second quadrant Q2 on the diagonal thereto is selected as the dispersant. That is, when δPₛ≤δP_{w} and δDₛ≥δD_{w}, a substance having coordinates Cₐ satisfying δPₐ≥δP_{w} and δDₐ≤δD_{w} is selected as the scale dispersant.

Similarly, when the coordinates Cₛ of the target scale is in the first quadrant Q1, a substance having coordinates Cₐ(δDₐ, δPₐ) in the third quadrant Q3 on the diagonal thereto is selected as the dispersant. That is, when δPₛ≥δP_{w} and δDₛ≥δD_{w}, a substance having coordinates Cₐ satisfying δPₐ≤δP_{w} and δDₐ≤δD_{w} is selected as the scale dispersant.

When the coordinates Cₛ of the target scale is in the second quadrant Q2, a substance having coordinates Cₐ(δDₐ, δPₐ) in the fourth quadrant Q4 on the diagonal thereto is selected as the dispersant. That is, when δPₛ≥δP_{w} and δDₛ≤δD_{w}, a substance having coordinates Cₐ satisfying δPₐ≤δP_{w} and δDₐ≥δD_{w} is selected as the scale dispersant.

When the coordinates Cₛ of the target scale is in the third quadrant Q3, a substance having coordinates Cₐ(δDₐ, δPₐ) in the first quadrant Q1 on the diagonal thereto is selected as the dispersant. That is, when δPₛ≤δP_{w} and δDₛ≤δD_{w}, a substance having coordinates Cₐ satisfying δPₐ≥δP_{w} and δDₐ≥δD_{w} is selected as the scale dispersant.

Also, in the present aspect, the value of δHₐ of the scale dispersant is not particularly limited.

The selection steps according to the second aspect and the variation thereof are advantageous over the first aspect in that it is possible to further limit an effective dispersant.

### Third Aspect: Selection Based on Affinity with Target Water in Two-Dimensional Coordinates

According to a third aspect, step (c) of selecting a scale dispersant relates to a selection method in a two-dimensional coordinate space consisting of a dispersion force δD and a dipole-dipole force δP. When the coordinates of the target scale are designated as Cₛ(δDₛ, δPₛ), the coordinates of the target water are designated as C_{w}(δD_{w}, δP_{w}), the coordinates of a scale dispersant to be selected are designated as Cₐ(δDₐ, δPₐ), and the distance between the coordinates C_{w} and the coordinates Cₛ is designated as Rₐ, the step of selecting a scale dispersant according to the third aspect is,

(1) when Rₐ is 9.5 or less,
a step of selecting a substance having coordinates Cₐ satisfying δDₐ being (δD_{w}−0.5) to (δD_{w}+4.5) and δPₐ being (δP_{w}−10) to (δP_{w}+8) as the scale dispersant, and
(2) when Rₐ is greater than 9.5,
a step of selecting a substance having coordinates Cₐ satisfying δDₐ being (δD_{w}+0.5) to (δD_{w}+4.5) and δPₐ being (δP_{w}−10) to (δP_{w}+8) as the scale dispersant.

### (1) Scale Having Good Affinity with Water (Rₐ≤9.5)

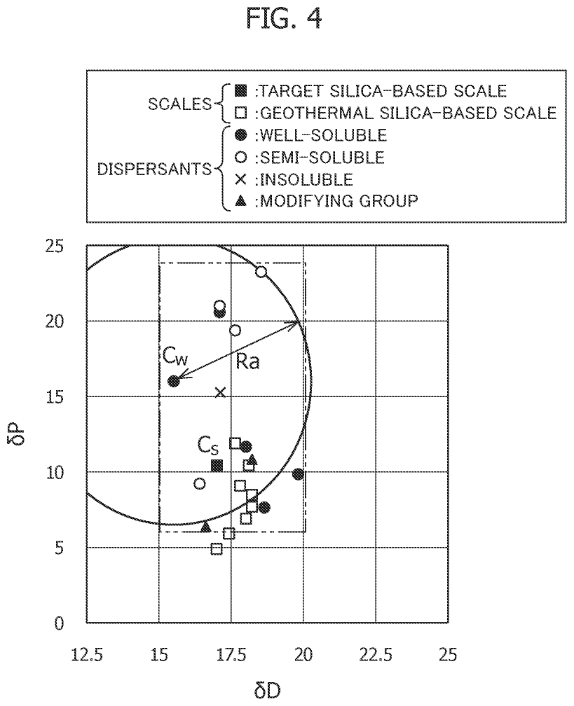

With reference to FIG. 4, in a two-dimensional coordinate space consisting of a dispersion force δD and a dipole-dipole force δP, a circle centered at the coordinates C_{w} of the target water and having a radius Rₐ=9.5 is shown. When the coordinates Cₛ of the target scale is on the circle or inside the circle, this scale is defined as a scale having good affinity with the target water. In this case, a substance having coordinates Cₐ satisfying δDₐ being (δD_{w}−0.5) to (δD_{w}+4.5) and δPₐ being (δP_{w}−10) to (δP_{w}+8) can be selected as the scale dispersant.

In addition, also in the present aspect, it is not necessary to consider the hydrogen bonding force of the dispersant, and the dispersant hydrogen bonding force term δHₐ may have any value.

In FIG. 4, a suitable region in which the coordinates Cₐ of a scale dispersant having good affinity with water selected based on the target water coordinates C_{w}(δD_{w}=15.5, δP_{w}=16) when pure water is the target water are located is shown by a two-dot chain line. In FIG. 4, the coordinate values of the target silica-based scale and the geothermal silica-based scale that were actually obtained are plotted. In addition, the coordinate values of various dispersants and substances used as modifying groups for a dispersant are plotted. In FIG. 4, the target silica-based scale is the coordinates of the silica-based scale used for selection as the target scale in the selection method in the present aspect, and the geothermal silica-based scale is the coordinates of the silica-based scale derived from a geothermal power plant in Japan. In addition, in FIG. 4, “Well-soluble,” “Semi-soluble,” and “Insoluble” indicate the dispersiveness of the dispersants. Specifically, these ratings are the results obtained by evaluation based on the degree of turbidity when each of the dispersants is added to pure water at a concentration of 0.2% by mass and mixed in a bottle. Well-soluble means that more than half of the liquid in the bottle is turbid, indicating that the dispersant is highly dispersive; Semi-soluble means that half of the liquid in the bottle is turbid; and Insoluble means that either a precipitate in the liquid in the bottle is generated or less than half of the liquid is turbid, indicating that the dispersant is poorly dispersive.

### (2) Scale Having Poor Affinity with Water (Rₐ>9.5)

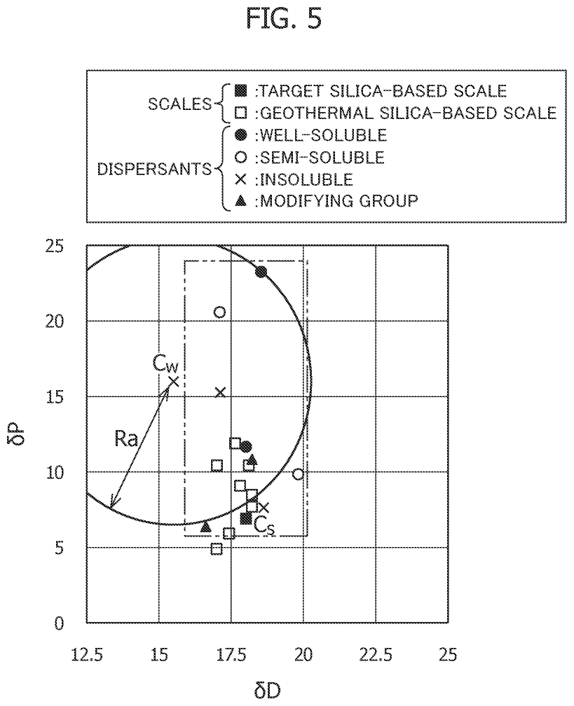

Next, with reference to FIG. 5, as in FIG. 4, a circle centered at the coordinates C_{w} of the target water and having a radius Rₐ=9.5 is shown, and the coordinates Cₛ of the target scale are outside the circle. This scale is defined as a scale having poor affinity with the target water. In this case, a substance having coordinates Cₐ satisfying δDₐ being (δD_{w}+0.5) to (δD_{w}+4.5) and δPₐ being (δP_{w}−10) to (δP_{w}+8) can be selected as the scale dispersant.

In FIG. 5, a suitable region in which the coordinates Cₐ of a scale dispersant suitable for a scale having poor affinity with water selected based on the target water coordinates C_{w}(δD_{w}=15.5, δP_{w}=16) are located is shown by a two-dot chain line when pure water is the target water. In FIG. 5, the coordinate values of the target silica-based scale and the geothermal silica-based scale that were actually obtained are plotted. In addition, the coordinate values of various dispersants and substances used as modifying groups for a dispersant are plotted.

The step of selecting a scale dispersant according to the third aspect is advantageous in that it is possible to select a further effective agent as compared with the first aspect and the second aspect.

According to the first embodiment of the present invention, a scale dispersant compatible with a target water and a target scale can be selected. Therefore, it is possible to select a scale dispersant for each plant system in which scale adhesion is a concern, and highly efficient suppression of scale adhesion is possible.

### Second Embodiment: Method for Producing Scale Dispersant

According to a second embodiment, the present invention relates to a method for producing a scale dispersant. The method for producing a scale dispersant includes the following steps:
selecting a scale dispersant or a modifying group having a predetermined coordinate based on the method for selecting a scale dispersant according to the first embodiment; and
preparing a scale dispersant based on the selected scale dispersant or modifying group.

The first step of the present embodiment can be carried out by the method described in the first embodiment, and thus, description thereof will be omitted here. In the second step, a scale dispersant can be prepared by using a compound, a monomer, or a modifying group, which is the dispersant selected in the first step, and as necessary, through the step of synthesizing a polymer compound or modifying the main chain with a modifying group. A scale dispersant can also be prepared by combining two or more of the dispersants selected in the first step. For example, a scale dispersant can also be prepared by using a combination of the chelating agent selected in the first step and a polymer compound having a modifying group also selected in the first step.

According to the present embodiment, a scale dispersant according to the components of the target water and the target scale can be produced, and the scale dispersant can be used to suppress scale adhesion.

### Third Embodiment: Method for Suppressing Scale Adhesion

According to a third embodiment, the present invention relates to a method for suppressing scale adhesion. The method for suppressing scale adhesion includes the following steps:
(I) selecting a scale dispersant by the method for selecting a scale dispersant according to the first embodiment; and
(II) adding the selected scale dispersant to geothermal water in a geothermal power generation system, in which the step of selecting a scale dispersant includes a step of obtaining a coordinate C_{w} of an intrinsic physical property value of the geothermal water.

Step (I) of the present embodiment can be carried out by the method described in the first embodiment. In the present embodiment, the target scale is scale deposited in a geothermal power generation system, and the target water is geothermal water at a site to which a scale dispersant is added. Therefore, in the method for suppressing scale adhesion according to the present embodiment, a scale dispersant can be selected in such a way as to be compatible with the target water in the target geothermal power generation system.

For example, in a geothermal power generation system that obtains geothermal water from two or more production wells, the composition of the geothermal water obtained from each production well may differ, and the coordinates C_{w} of intrinsic physical property values based on HSP can also differ. In this case, step (I) of the present embodiment preferably includes a step of obtaining coordinates C_{w} of intrinsic physical property values of geothermal water derived from two or more different production wells, and includes a step of selecting a scale dispersant corresponding to the geothermal water derived from each of the production wells. For example, it is preferable to separately select a first scale dispersant compatible with a first target water obtained from a first production well and a second scale dispersant compatible with a second target water obtained from a second production well.

In step (II), the scale dispersant selected in step (I) is prepared, and the scale dispersant is added to the target water. The mode of addition may be intermittent or continuous. In addition, the amount of the scale dispersant added can be appropriately determined by those skilled in the art.

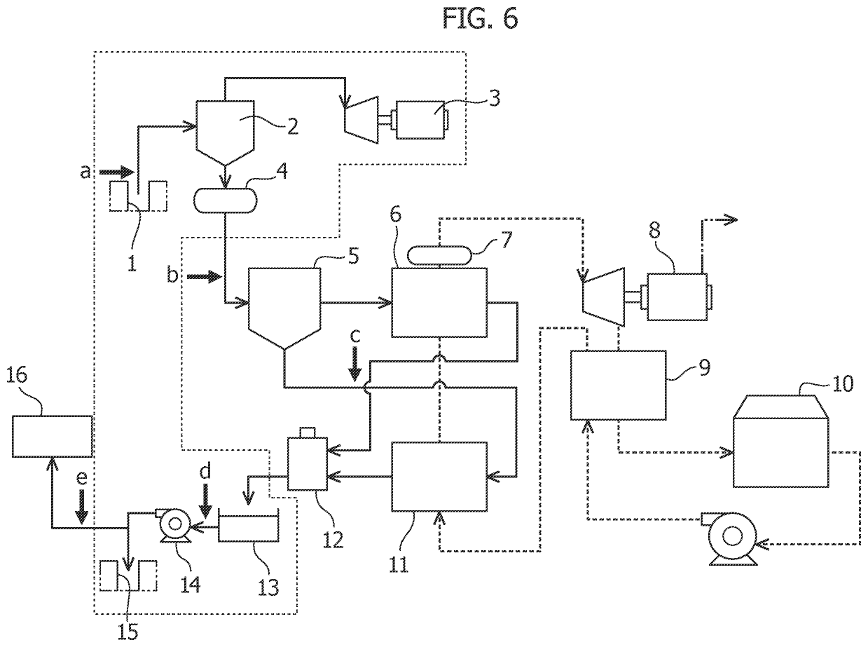

Next, with reference to FIG. 6, the geothermal power generation system and the mode of addition of the scale dispersant will be described. FIG. 6 is a conceptual flow diagram showing an example of a binary cycle type geothermal power generation system. The geothermal power generation system can be composed of a production well 1, a first steam separator 2, a first turbine generator 3, a hot water tank 4, a second steam separator 5, an evaporator 6, a separator 7, a second turbine generator 8, a feed heater 9, an air-cooled condenser 10, a preheater 11, a flash tank 12, a hot water pit 13, a reinjection pump 14, and an injection well 15. The geothermal power generation system may optionally include a facility that carries out subsequent heat utilization 16. In FIG. 6, the flow of geothermal water is shown by solid line arrows, and the flow of a low boiling point medium is shown by broken line arrows. In addition, the region surrounded by a broken line indicates a flash power generation region.

The flow of substances in the geothermal power generation system will be briefly described. Production well 1 is a well that brings hot water, steam, or a mixture thereof (geothermal water) present in an underground geothermal reservoir to the surface. Geothermal water brought from production well 1 is separated into steam, which is a gaseous component, and hot water, which is a liquid component, in first steam separator 2. The separated steam is led to first turbine generator 3 and is used to rotate the turbine, causing the generator to produce electricity. The steam that has passed through first turbine generator 3 is cooled in a condenser not shown and is led to injection well 15 through a pipe (not shown). On the other hand, the hot water separated in first steam separator 2 is led to second steam separator 5 via hot water tank 4. The gaseous component separated in second steam separator 5 is led to evaporator 6, and it is used to heat a low boiling point solvent in evaporator 6. The hot water liquefied again by heating the low boiling point solvent is then led to flash tank 12. The liquid component separated in second steam separator 5 is led to preheater 11 to heat a low boiling point medium, and is then led to flash tank 12. In flash tank 12, the hot water is depressurized and the generated water vapor is dissipated into the atmosphere. The remaining liquid component after depressurization is led to hot water pit 13, a part thereof is returned to injection well 15 by reinjection pump 14, and another part thereof is led to facility that carries out subsequent heat utilization 16, such as a hot spring facility.

On the other hand, the low boiling point medium is circulating within the equipment as shown by the broken line arrows. The low boiling point medium is heated by geothermal steam in evaporator 6, the low boiling point medium in a two-phase flow is separated into a gas phase and a liquid phase in separator 7, and the low boiling point medium in the gas phase is led to second turbine generator 8. The low boiling point medium used to rotate the turbine is condensed and liquefied in feed heater 9, heat is dissipated in air-cooled condenser 10, and the medium is led to preheater 11. In preheater 11, the liquefied low boiling point medium is heated again by geothermal water and circulated to evaporator 6.

In the present embodiment, the scale dispersant is preferably added at one or more of the following points: arrow a immediately after blowing from the production well, arrow b going to second steam separator 5 via first steam separator 2, arrow c going to preheater 11 via second steam separator 5, arrow d going from hot water pit 13 to reinjection pump 14, or arrow e sent from reinjection pump 14 to a facility that carried out subsequent heat utilization 16. The addition at the point shown by arrow a has the effect of dispersing silica adhering to a steam pipe, a heat exchanger, a steam separator, a valve, or the like. The type of the scale dispersant added at each point may be the same or different. When the geothermal water flowing through the addition point has a different composition, selecting and adding a scale dispersant compatible with each composition is most suitable in the method for suppressing scale adhesion.

The geothermal power generation system in which the method for suppressing scale adhesion according to the present embodiment is practiced can be applied to any geothermal power generation system, which is limited to the binary cycle type geothermal power generation system shown.

According to the method for suppressing scale adhesion according to the present embodiment, it is possible to effectively and economically suppress scale adhesion by using a dispersant selected depending on the target water and the target scale in the geothermal power generation system.

### Industrial Applicability

The method for selecting a scale dispersant, the method for producing a scale dispersant, and the method for suppressing scale according to the present invention can be applied to suppression of scale adhesion in various plant systems.

### Reference Symbol List

Cₛ Coordinates of target scale

C_{w} Coordinates of target water

Q1 First quadrant

Q2 Second quadrant

Q3 Third quadrant

Q4 Fourth quadrant

1. A method for selecting a scale dispersant, comprising steps of:
obtaining a coordinate Cₛ of an intrinsic physical property value, based on Hansen solubility, of a target scale;
obtaining a coordinate C_{w} of an intrinsic physical property value, based on Hansen solubility, of a target water; and
selecting a scale dispersant based on a positional relationship between the coordinate Cₛ of the intrinsic physical property value of the target scale and the coordinate C_{w} of the intrinsic physical property value of the target water.

2. The method for selecting a scale dispersant according to claim 1, wherein
when the intrinsic physical property values are expressed by three-dimensional coordinates consisting of a dispersion force δD, a dipole-dipole force δP, and a hydrogen bonding force δH,
coordinates of the target scale are designated as Cₛ(δDₛ, δPₛ, δHₛ),
coordinates of the target water are designated as C_{w}(δD_{w}, δP_{w}, δH_{w}),
coordinates of a scale dispersant to be selected are designated as Cₐ(δDₐ, δPₐ, δHₐ), and
a distance between the coordinates Cₛ of the intrinsic physical property values of the target scale and the coordinates C_{w} of the intrinsic physical property values of the target water is designated as Rₐ,
the step of selecting a scale dispersant is a step of selecting a substance having coordinates Cₐ satisfying the following expression (1):
4(δDₐ−δD_{w})²+(δPₐ−δP_{w})²+(δHₐ−δH_{w})²≤(Rₐ)² (1)
as the scale dispersant.

3. The method for selecting a scale dispersant according to claim 1, wherein
when the intrinsic physical property values are expressed by two-dimensional coordinates consisting of a dispersion force δD and a dipole-dipole force δP,
coordinates of the target scale are designated as Cₛ(δDₛ, δPₛ),
coordinates of the target water are designated as C_{w}(δD_{w}, δP_{w}), and
coordinates of a scale dispersant to be selected are designated as Cₐ(δDₐ, δPₐ),
the step of selecting a scale dispersant is,
(i) when δPₛ≥δP_{w}, a step of selecting a substance having coordinates Cₐ satisfying δPₐ≤δP_{w} as the scale dispersant; and
(ii) when δPₛ≤δP_{w}, a step of selecting a substance having coordinates Cₐ satisfying δPₐ≥δP_{w} as the scale dispersant.

4. The method for selecting a scale dispersant according to claim 3, wherein the step of selecting a scale dispersant is,
(ia) when δPₛ≥δP_{w} and δDₛ≥δD_{w}, a step of selecting a substance having coordinates Cₐ satisfying δPₐ≤δP_{w} and δDₐ≤δD_{w} as the scale dispersant;
(ib) when δPₛ≥δP_{w} and δDₛ≤δD_{w}, a step of selecting a substance having coordinates Cₐ satisfying δPₐ≤δP_{w} and δDₐ≥δD_{w} as the scale dispersant;
(iia) when δPₛ≤δP_{w} and δDₛ≤δD_{w}, a step of selecting a substance having coordinates Cₐ satisfying δPₐ≥δP_{w} and δDₐ≥δD_{w} as the scale dispersant; and
(iib) when δPₛ≥δP_{w} and δDₛ≥δD_{w}, a step of selecting a substance having coordinates Cₐ satisfying δPₐ≥δP_{w} and δDₐ≤δD_{w} as the scale dispersant.

5. The method for selecting a scale dispersant according to claim 1, wherein
when the intrinsic physical property values are expressed by two-dimensional coordinates consisting of a dispersion force δD and a dipole-dipole force δP,
coordinates of the target scale are designated as Cₛ(δDₛ, δPₛ),
coordinates of the target water are designated as C_{w}(δD_{w}, δP_{w}),
coordinates of a scale dispersant or a modifying group therefor to be selected are designated as Cₐ(δDₐ, δPₐ), and
a distance between the coordinates C_{w} and the coordinates Cₛ is designated as Rₐ, the step of selecting a scale dispersant is,
(1) when Rₐ is 9.5 or less,
a step of selecting a substance having coordinates Cₐ satisfying δDₐ being (δD_{w}−0.5) to (δD_{w}+4.5) and δPₐ being (δP_{w}−10) to (δP_{w}+8) as the scale dispersant; and
(2) when Rₐ is greater than 9.5,
a step of selecting a substance having coordinates Cₐ satisfying δDₐ being (δD_{w}+0.5) to (δD_{w}+4.5) and δPₐ being (δP_{w}—10) to (δP_{w}+8) as the scale dispersant.

6. The method for selecting a scale dispersant according to claim 1, wherein the target water is selected from clean water, sewage, well water, seawater, freshwater, river water, pure water, geothermal water, industrial water, and factory effluent.

7. The method for selecting a scale dispersant according to claim 1, wherein the scale dispersant is selected from allylamine, diallylamine, maleic acid, ascorbic acid, nicotinic acid, acrylic acid, dimethyldiallylammonium chloride, difurfuryl disulfide, sulfur dioxide, or a polymer comprising one monomer thereof or two or more monomers thereof.

8. The method for selecting a scale dispersant according to claim 7, wherein the scale dispersant comprises a chelating agent.

9. A method for producing a scale dispersant, comprising steps of:
selecting a scale dispersant or a modifying group having a predetermined coordinate based on the method for selecting a scale dispersant according to claim 1; and
preparing a scale dispersant based on the selected scale dispersant or modifying group.

10. A method for suppressing scale adhesion in a geothermal power generation system, the method comprising steps of:
(I) selecting a scale dispersant by the method for selecting a scale dispersant according to any one of claim 1; and
(II) adding the selected scale dispersant to geothermal water in the geothermal power generation system,
wherein the step of selecting a scale dispersant comprises a step of obtaining a coordinate C_{w} of an intrinsic physical property value of the geothermal water.

11. The method according to claim 10, wherein the method comprises a step of obtaining coordinates C_{w} of intrinsic physical property values of geothermal water derived from two or more different production wells, and comprises a step of selecting a scale dispersant corresponding to the geothermal water derived from each of the production wells.
